(19) United States
(12) Patent Application Publication
(10) Pub. No.: US 2007/0295751 A1
(43) Pub. Date: Dec. 27, 2007

(54) CLEANING IMPLEMENT

(76) Inventors: David Jackson Lestage, Livermore, CA (US); Marc Privitera, Walnut Creek, CA (US); Edward Rinker, Oakland, CA (US)

Correspondence Address: THE CLOROX COMPANY, P.O. BOX 24305, OAKLAND, CA, 94623-1305, US

(21) Appl. No.: 11/426,779

(22) Filed: Jun. 27, 2006

(51) Int. Cl. B29C 71/00; B29C 41/02; B29C 41/20

(52) U.S. Cl. 222/148; 264/236; 264/259

(57) ABSTRACT

A cleaning implement for cleaning surfaces is provided. The cleaning implement forms instantaneously at point of use. A curing solution is discharged under pressure into a mold. The curing solution when exposed to ambient temperature and pressure, cures quickly to generate the cleaning implement. The cleaning implement is a cross linked polymeric structure which is pliable, flexible and has absorbent properties.

### FIELD OF THE INVENTION

The present invention relates generally to cleaning implements, and cleaning systems for cleaning surfaces.

### BACKGROUND OF THE INVENTION

Cleaning implements and systems for household and industrial applications are well known in the art. Cleaning implements for cleaning surfaces such as floor surfaces, and objects are widely available. Examples of cleaning implements may include sponges, swabs, wipes and the like. European patent publication No. 1511577A2 discloses a method and an apparatus to produce a non-woven fabric. A composition comprising fibres, a binder and a diluent is sprayed onto a supporting surface to form the non-woven fabric.

U.S. Pat. No. 3,705,669A discloses a foamable resinous composition for producing an adhesive string of plastic foam. The foam has flexible and adhesive properties. This foam may be used for cleaning purposes. However, the existing cleaning systems using these cleaning implements are characterized by one or more inadequacies. The shape of the conventional cleaning implement is usually not in accordance with the surface to be cleaned. Hence, complete cleaning of the surface may not be possible. Further, a cleaning implement needs to be replaced with a fresh cleaning implement when it becomes worn out or soiled beyond utility. This results in waste of time since fresh cleaning implements are not generated instantly. Furthermore, there is a requirement of additional abrasives when the cleaning implement is required to clean hard surfaces.

In view of the present state of the art of cleaning implements and systems, there is a need for a system that quickly generates a cleaning implement at the time and location of application and can be rapidly molded into a variety of shapes. Further, there is a need for a cleaning implement that can effectively clean hard surfaces.

### SUMMARY OF THE INVENTION

In view of the foregoing, the present invention provides a cleaning implement that can be generated instantaneously at the site of application. A curing solution is discharged under pressure onto a surface which needs to be cleaned. The curing solution when exposed to ambient temperature and pressure, cures instantaneously to generate the cleaning implement. The structure of the cleaning implement is a matrix of entangled and/or cross linked polymers. Further, the cleaning implement can be molded into a variety of shapes based on the cleaning job to be performed.

In one embodiment of the present invention, a pad is placed in the mold prior to the discharge of the curing solution into the mold. The pad may include one or more cleaning actives. The cleaning implement formed after curing, may absorb one or more cleaning actives from the pad. The cleaning implement may further desorb one or more cleaning actives to a surface to be cleaned. In another embodiment of the present invention, a coupler may be used to secure the cleaning implement or the cleaning implement with the pad. In yet another embodiment of the present invention, the curing solution may include one or more cleaning actives.

The features of the present invention will become apparent to one of ordinary skill in the art upon reading the detailed description, in conjunction with the accompanying drawings and claims, provided herein.

### BRIEF DESCRIPTION OF THE DRAWINGS

FIG. 1 illustrates a cleaning system in accordance with an exemplary embodiment of the present invention; and

FIG. 2 illustrates a cleaning implement being cured in a mold, in accordance with an exemplary embodiment of the present invention.

### DETAILED DESCRIPTION OF THE INVENTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, some of the preferred materials and methods are described herein.

Various embodiments of the present invention relate to methods and systems for generating a cleaning implement such as a sponge instantaneously. The cleaning implement is generated by instantaneous curing of a curing solution. The curing solution when discharged under pressure readily cures to generate the cleaning implement with absorbent properties.

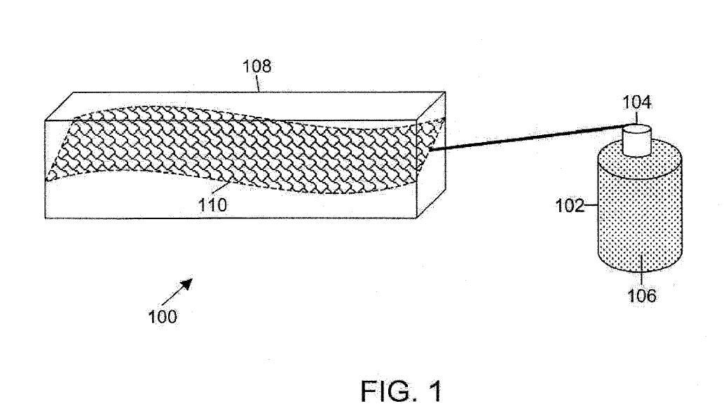

FIG. 1 illustrates a cleaning system 100 in accordance with an exemplary embodiment of the present invention. Cleaning system 100 includes a pressurized container 102 such as an aerosol can. Pressurized container 102 includes a curing solution 106. Curing solution 106 is discharged under pressure into a mold 108. Curing solution 106 cures instantaneously to generate a cleaning implement 110. In other words, curing solution 106 cures within a period of time that is acceptable to the user of cleaning implement 110. Cleaning implement 110 has a cross linked polymeric structure. Cleaning implement 110 is removed from the mold 108 after cure. Cleaning implement 110 may then be utilized for cleaning purposes.

In various embodiments of the invention, pressurized container 102 may be any closed container that is capable of withstanding an internal pressure, which is sufficient to keep curing solution 106 in liquid phase at ambient temperature. Pressurized container 102 may include a discharge valve 104 to allow discharge of curing solution 106. In an embodiment of the invention, pressurized container 102 may include a device such as a flexible diaphragm, piston or bellows, to separate the interior of pressurized container 102 into two zones. The first zone which is in contact with discharge valve 104 may contain curing solution 106 and the second zone may contain a propellant which pressurizes pressurized container 102 in excess of a vapor pressure of curing solution 106. The propellant may be a compressed gas such as nitrogen, nitrous oxide, carbon dioxide and the like. Examples of such pressurized containers are disclosed in U.S. Pat. Nos. 2,815,152, 3,245,591 and 3,407,974.

In an embodiment of the present invention, curing solution 106 includes a formulated resin component and an isocyanate component. The formulated resin component may include a first polyol having at least multi-functionality. The number-average molecular weight of the first polyol ranges from 100 to 1000 (including all subranges in between). The formulated resin component may further include a second polyol having terminal hydroxyl groups such as triols, diols and the like. The number-average molecular weight of the second polyol ranges from 2000 to 10000 (including all subranges in between). The weight percentage of the first polyol and the second polyol ranges between 60 to 80 percentage (including all subranges in between). Examples of the first polyol and the second polyol include materials derived from polyether polyols such as poly(oxytetramethylene) glycols, poly(oxypropylene) triols.

The weight percentage of the isocyanate component ranges between 20 to 30 percentage (including all subranges in between). Examples of the isocyanate component include, but are not limited to aromatic, aliphatic, cycloaliphatic polyisocyanates and combinations thereof. Examples of diisocyanates include m-phenylene diisocyanate, 2,4-toluene diisocyanate, 2,6-toluene diisocyanate, mixtures of 2,4- and 2,6-toluene diisocyanate, hexamethylene diisocyanate, tetramethylene diisocyanate, cyclohexane-1,4-diisocyanate, hexahydrotoluene diisocyanate, naphthalene-1,5-diisocyanate, 1-methoxyphenyl-2,4-diisocyanate, 4,4′-diphenylmethane diisocyanate, 4,4′-biphenylene diisocyanate, 3,3-dimethoxy-4,4′-biphenyl diisocyanate, 3,3′-dimethoxy-4,4′-biphenyl diisocyanate, 3,3′-dimethyl-4,4′-biphenyl diisocyanate, 3,3′-dimethyldiphenylmethane-4,4′-diisocyanate and so forth. Examples of triisocyanates include 4,4′,4″-triphenylmethane triisocyanate, toluene 2,4,6-triisocyanate. Examples of tetraisocyanates include 4,4′-dimethyldiphenylmethane-2,2′-5,5′-tetraisocyanate and so forth. Examples of polymeric polyisocyanates include polymethylene polyphenylene polyisocyanate and so forth.

The isocyanate component mixes with the formulated resin component to form the crosslinked polymeric structure of cleaning implement 110. The isocyanate component mixes with the formulated resin component in a volumetric ratio which ranges from 1:1 to 1:10 (including all sub-ranges in between). The mixing occurs by polymerization of the formulated resin component and the isocyanate component, and simultaneous expansion of a gas through curing solution 106. The gas that is used for expansion may include carbon dioxide, nitrogen, nitrous oxide, and the like. Cleaning implement 110 thus formed is a polyurethane foam or sponge.

Curing solution 106 may further include a curing component having at least one primary amine group. The curing component may be present in an amount ranging between 2 to 15 parts (including all subranges in between) by weight based on 100 parts by weight of the formulated resin component. The number-average molecular weight of the curing component ranges from 100 to 5000 (including all subranges in between).

Furthermore, curing solution 106 may include a blowing agent to improve the foaming property of curing solution 106. The blowing agent may be present in an amount ranging from 15 to 40 parts (including all subranges in between) by weight based on 100 parts by weight of the formulated resin component. The weight percentage of the blowing agent ranges between 2.5 to 5.0 percentage (including all subranges in between). Examples of the blowing agent include water, a plurality of hydrocarbons, chlorinated hydrocarbons, fluorinated hydrocarbons and the like.

Curing solution 106 may further include one or more additives such as a catalyst, an emulsifier, a surfactant, a flame retardant, a preservative, a disinfectant, a sanitizer, and so forth. The catalyst may be present in an amount ranging between 0 to 18 parts (including all subranges in between) by weight based on 100 parts by weight of the formulated resin component. The weight percentage of the catalyst ranges between 0.1 to 5.0 percentage (including all subranges in between). Examples of the catalyst include, but are not limited to pentamethyldiethyltriamine, dimethyltin dimercaptide, dimethylethanolamine, and mixtures thereof. The catalysts may also be metal salt catalysts which cause reaction of the residual isocyanate component to form stable isocyanurate functionality. Examples of metal salt catalysts include alkali salts of organic acids such as sodium salts of organic acids, potassium salts of organic acids, stannous octoate and so forth.

The emulsifier may be present in an amount ranging between 0 to 5 parts (including all subranges in between) by weight based on 100 parts by weight of the formulated resin component. Examples of the emulsifier include, but are not limited to oleic acid, nonyl phenol ethoxylate and so forth.

The surfactant may be present in an amount ranging between 0 to 5 parts (including all subranges in between) by weight based on 100 parts by weight of the formulated resin component. The weight percentage of the surfactant ranges between 0.1 to 5.0 percentage (including all subranges in between). Examples of the surfactant include, but are not limited to alkyl sulfonic ester, silicon glycol copolymer and so forth.

The flame retardant increases the flame resistance of cleaning implement 110. The flame retardant may be present in an amount ranging between 15 to 40 parts (including all subranges in between) by weight based on 100 parts by weight of the formulated resin component. The weight percentage of the flame retardant ranges between 5.0 to 8.0 percentage (including all subranges in between). Examples of the flame retardant include, but are not limited to ammonium phosphate, ammonium polyphosphate, mono ammonium phosphate, melamine, tetrakis(2-chloroethyle) ethylene phosphate, pentabromodiphenyl oxide, tris(1,3-dichloropropyl) phosphate, tris(beta-chloroethyle) phosphate, molybdenum trioxide, ammonium molybdate, pentabromodiphenyloxide, tricresyl phosphate, 2,3-dibromopropanaol, hexabromo-cyclododecane, dibromoethyldibromocyclohexane, tris(2,3-dibromopropyl) phosphate, tris(beta-chloropropyl) phosphate, chlorowax 70, dicyandiamide, oxamide, biuret and so forth.

An exemplary composition of curing solution 106 pertaining to the above described embodiment includes:
60 wt/wt % poly(oxytetramethylene) glycols as polyols
30 wt/wt % tetramethylene diisocyanate as an isocyanate component
1.0 wt/wt % curing component
2.0 wt/wt % water as blowing agent
0.5 wt/wt % stannous octoate as a catalyst
0.5 wt/wt % oleic acid as an emulsifier
1.0 wt/wt % sorbitan ester as a surfactant
5.0 wt/wt % hexabromobenzene as a flame retardant

In another embodiment of the present invention, curing solution 106 includes a polymeric resin component such as an alkyl acrylate, an alkyl methacrylate polymer, an alkyl methacrylate copolymer and the like. The weight percentage of the polymeric resin component ranges between 5.0 to 20.0 percentage (including all subranges in between). Examples of the polymeric resin component include, but are not limited to, polyisobutyl methacrylate, polyisopropyl methacrylate, polyisopentyl methacrylate, polyisohexyl methacrylate, polyisoheptyl methacrylate, polyisooctyl methacrylate, polyvinyl pyrrilidone, polyvinyl acetate-butyrate, polyvinyl butyral, and mixtures thereof.

The polymeric resin component may also include thermoplastic, non-homogeneous and homogeneous polymers. The examples of thermoplastic polymers include, but are not limited to acrylonitrile-butadiene-styrene, acetal resins such as polyoxymethylene, acrylics such as poly(methacrylate), cellulose acetate, cellulose acetate butyrate, cellulose propionate, polycarbonates, soluble polyolefins, polyisobutylene, polybutadiene, butyl rubber, styrene-butadiene, styrene polymers and copolymers, soluble urethanes, polyvinyl acetate, ethylene acetate, vinyl acetate and the like. Examples of homogeneous polymers include, but are not limited to polyvinyl acetate, vinyl chloride, vinyl acetate copolymers, polystyrene, styrene, alpha-methyl styrene, styrene-butadiene copolymers, styrene-acrylonitrile copolymers, vinyl chloride, polystyrene, styrene, alpha-methyl styrene, styrene-butadiene copolymers, styrene-acrylonitrile copolymers and the like. Examples of non-homogeneous polymer systems include, but are not limited to polyblends and grafts copolymers such as high impact polystyrene, acrylonitrile-butadiene-styrene and the like.

In addition to the polymeric resin component, curing solution 106 includes a fluorinated propellant. The weight percentage of the fluorinated propellant ranges between 72.0 to 80.0 percentage (including all subranges in between).

Curing solution 106 may further include a plasticizer to maintain the plasticity of cleaning implement 110. The plasticizer may be a temporary or permanent plasticizer. The weight percentage of the plasticizer ranges between 1.0 to 3.0 percentage (including all subranges in between). Examples of the plasticizer include, but are not limited to butyl phthayl butyl glycolate, tributyl citrate, acetyl tributyl citrate, tricresyl phosphate, dibutyl tartrate, dibutyl phthalate, di-2-ethylhexylazetate, chlorinated biphenyl, methyl abietate. The plasticizer may also include pthalates such as diisonony, bis)n-butyl), butyl benzyl, diisodecyl, di-n-octyl, diethyl, diisobutyl, di-n-hexyl phthalate and the like.

Further, curing solution 106 may include an organic or an inorganic pigment to impart color to cleaning implement 110, such as, for example, titanium dioxide, carbon black, and other common pigments well known t those of ordinary skill in the art. The pigment may be colored or flouroscent. The weight percentage of the pigment ranges between 2.0 to 3.0 percentage (including all subranges in between).

Furthermore, curing solution 106 may include a co-solvent. The weight percentage of the co-solvent ranges between 3.0 to 4.0 percentage (including all subranges in between). Examples of the co-solvent include, but are not limited to isopentane, cyclopentane, 1,1-difluoro-1-chloroethane, dichlorofluorometane, trichlorofluoromethane, tetrachloroethylene and the like.

Curing solution 106 may further include a release agent such as a silicon fluid. The release agent prevents adhesion of cleaning implement 110 to the surface to be cleaned. Examples of the silicon fluid include, but are not limited to, dimethyl siloxane, methyl phenyl siloxane and the like.

In addition, curing solution 106 may include one or more additives such as a catalyst, an emulsifier, a surfactant, a flame retardant and so forth (examples of the additives have been described above.)

An exemplary composition of curing solution 106 pertaining to the above described embodiment includes:
8.0 wt/wt % polyisobutyl methacrylate as a polymeric resin
72 wt/wt % difluoroethane as a fluorinated propellant
1.0 wt/wt % diethylphthalate as a plasticizer
3.0 wt/wt % pigment
4.0 wt/wt % difluoromethane as a solvent
0.5 wt/wt % silicon fluid as a release agent
6.0 wt/wt % sorbitan ester as a surfactant
1.0 wt/wt % stannous octoate as a catalyst
0.5 wt/wt % oleic acid as an emulsifier
4.0 wt/wt % hexabromobenzene as a flame retardant

Curing solution 106 is discharged into mold 108 to generate cleaning implement 110 of desired shape. Mold 108 may be an open or closed mold of any desired shape. Curing solution 106 when discharged into mold 108 is exposed to ambient temperature and pressure, and cures instantaneously to form cleaning implement 110. In other words, curing solution 106 cures within a period of time that is acceptable to the user of cleaning implement 110. For example, the curing time of curing solution 106 may range between 2 to 10 seconds (including all subranges in between). In another example, depending on the size and location requirements of cleaning implement 110, the curing time of curing solution 106 may be about one minute. In an embodiment of the present invention, curing solution 106 may be discharged onto a surface which needs to be cleaned.

Cleaning implement 110 has a polymeric crosslinked structure of density ranging from 0.5 to one pound per cubic foot (including all subranges in between). Cleaning implement 110 is pliable and biodegradable. Cleaning implement 110 may be a fibrous, an open cellular, or a closed cellular structure or a combination thereof. Examples of the fibrous structure include a fabric, cotton and the like. Examples of the cellular structure include a sponge, a foam, a web and so forth.

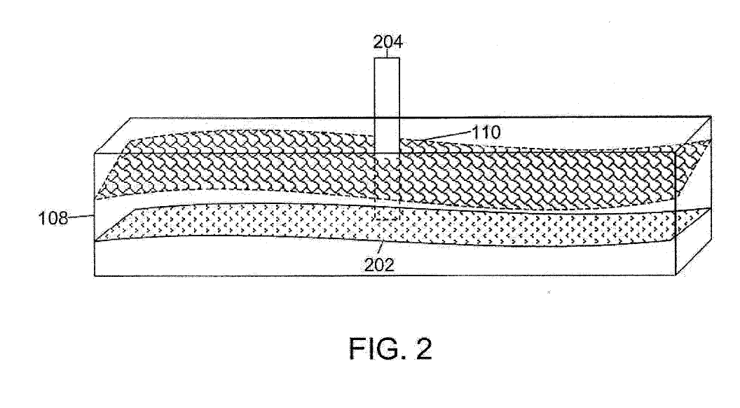

FIG. 2 illustrates cleaning implement 110 being cured in mold 108, in accordance with an exemplary embodiment of the present invention. A pad 202 may be placed in mold 108 prior to the discharge of curing solution 106 into mold 108. Pad 202 may be an abrasive pad, a non-woven pad, an absorbent pad and the like. In an embodiment of the present invention, more than one pad may be placed in mold 108. Cleaning implement 110 may absorb one or more actives from the pad. Examples of the one or more actives include, but are not limited to a disinfectant, a sanitizer, a disinfectant cleaner, an abrasive medium and the like. Cleaning implement 110 may further desorb one or more actives onto the surface to be cleaned. Cleaning implement 110 may be secured to pad 202 by a coupler 204. Coupler 204 may also act as a handle to assist in easy handling of cleaning implement 110 when cleaning implement 110 is being applied to the surface to be cleaned.

Various embodiments of the present invention provide methods and systems to generate a cleaning implement instantaneously at the time and location of application. Further, the cleaning implement can be molded into a variety of shapes. The cleaning implement can therefore be easily applied to any object to be cleaned. The cleaning implement is also pliable and flexible. Therefore, the cleaning implement can be stretched or compacted to be conformed to a shape of any object which is to be cleaned. Furthermore, the cleaning implement is biodegradable. The cleaning implement may be easily disposed by flushing, or dissolving in water. In addition, the cleaning implement absorbs or desorbs one or more cleaning actives. Further, the cleaning implement may contain additives from bio-mass such as bird feathers to improve the texture and absorbent property of the cleaning implement.

All references, including publications, patent applications, and patents, cited herein are hereby incorporated by reference to the same extent as if each reference were individually and specifically indicated to be incorporated by reference and were set forth in its entirety herein.

The use of the terms “a,” “an,” “the,” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

While the invention is described herein in connection with certain preferred embodiments, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. Skilled artisans may employ such variations as appropriate, and the invention may be practiced otherwise than as specifically described herein. Accordingly, the intent is to cover all alternatives, modifications, and equivalents included within the spirit and scope of the invention. Moreover, any combination of the above-described elements in all possible variations thereof is encompassed by the invention unless otherwise indicated herein or otherwise clearly contradicted by context.

We claim:

1. A method for generating a cleaning implement for surface cleaning, the method comprising the step of discharging a curing solution onto a surface, the curing solution being discharged under pressure, the curing solution curing instantaneously to form the cleaning implement.

2. The method of claim 1 further comprising the step of depositing one or more pads on the surface before discharging the curing solution.

3. The method of claim 2 wherein each of the one or more pads is selected from the group consisting of an abrasive pad, a non-woven pad, and an absorbent pad.

4. The method of claim 1 wherein the cleaning implement is a structure selected form the group consisting of polymeric structures, fibrous structures, cellular structures, and fibrous cellular mixture structures.

5. The method of claim 1 wherein the cleaning implement is disposable.

6. The method of claim 1 wherein the cleaning implement is pliable.

7. The method of claim 1 further comprising adding one or more actives to the curing solution.

8. The method of claim 7 wherein the one or more actives are selected from the group consisting of abrasive medium, a disinfectant, a sanitizer, a catalyst, an emulsifier, a surfactant, a flame retardant, a preservative and mixtures thereof.

9. The method of claim 1 further comprising the step of molding the discharged curing solution.

10. The method of claim 1 wherein the curing solution is a polymer based solution.

11. A cleaning implement for cleaning a surface, the cleaning implement comprising a curing solution, the curing solution being discharged under pressure, the curing solution curing instantaneously to form a polymeric structure.

12. The cleaning implement of claim 11, wherein the curing solution is a polymer based solution.

13. The cleaning implement of claim 11, wherein the cleaning implement is pliable.

14. The cleaning implement of claim 11, wherein the cleaning implement is capable of absorbing one or more actives.

15. The cleaning implement of claim 11, wherein the one or more actives is selected from the group consisting of an abrasive medium, a disinfectant, a sanitizer, a catalyst, an emulsifier, a surfactant, a flame retardant, a preservative and mixtures thereof.

16. The cleaning implement of claim 11, wherein the curing solution comprises one or more additives selected from the group consisting of a catalyst, a curing component, a pigment, a releasing agent, a flame retardant, a surfactant, an emulsifier, a plasticizer, and mixtures thereof.

17. The cleaning implement of claim 11, wherein the polymeric structure is selected from the group consisting of a fibrous structure, a cellular structure, and a fibrous cellular mixture structure.

18. The cleaning implement of claim 11, wherein the cleaning implement is capable of desorbing one or more actives.

19. The cleaning implement of claim 18, wherein the one or more actives is selected from the group consisting of at least one of an abrasive medium, a disinfectant, a sanitizer, a surfactant, and emulsifier, and mixtures thereof.

20. A cleaning system for cleaning a surface, the cleaning system comprising:
a pressurized container; and
a curing solution, the curing solution being contained in the pressurized container, the curing solution curing instantaneously when discharged from the pressurized container to form a cleaning implement.

21. The cleaning system of claim 20 further comprising one or more pads in contact with the curing solution before curing of the curing solution.
